(19) United States
(12) Patent Application Publication
(10) Pub. No.: US 2016/0273245 A1
(43) Pub. Date: Sep. 22, 2016

(54) MOTOR VEHICLE CONTROL DEVICE

(71) Applicant: KIEKERT AG, Heiligenhaus (DE)

(72) Inventor: Thorsten Bendel, Oberhausen, North Rhine-Westphalia (DE)

(21) Appl. No.: 15/021,973

(22) PCT Filed: Sep. 4, 2014
(86) PCT No.: PCT/DE2014/100305

§ 371 Date: Apr. 28, 2016

(30) Foreign Application Priority Data
Sep. 16, 2013 (DE) 10 2013 110 194.1

(51) Int. Cl. E05B 79/10; E05B 85/26; E05B 85/24

(52) U.S. Cl. CPC E05B 79/10; E05B 85/243; E05B 85/26

(57) ABSTRACT

The subject matter of the present invention is a motor vehicle control device that is provided with at least two closing/securing parts that can move relative to each other in pairs. The closing/securing parts each have functional surfaces on the edges which can be brought into contact mechanically. The closing/securing parts are produced from a planar base material and have, at their edges, machining marks created during the production process. According to the invention, one closing/securing part is provided with a bent section in such a way that the unprocessed bent section surface at least partially defines the functional surface of the relevant closing/securing part.

### BACKGROUND

The invention relates to a motor vehicle actuator, in particular a motor vehicle door actuator, preferably a motor vehicle door latch actuator, with at least two paired movable closure/securing components, whereby the closure/securing components are equipped with functional surfaces on the edge side which can be respectively mechanically brought into contact with one another, and whereby the closure/securing components are manufactured from a two-dimensional base material with processing traces caused by the production process on its edges.

A motor vehicle actuator with at least two paired movable closure/securing components generally means a device which is used, for example, for motor vehicle door latches, tailgates, closure aids, closure mechanisms for sliding doors, seat adjustment devices, trunk covers, sunroofs, etc. In fact, these known motor vehicle actuators are generally characterized in that the at least two paired movable closure/securing components executed here are power transmission and/or securing devices. To this end, the closure/securing components are regularly pivoted around a respective axis or also shifted in a linear manner or along a curve. Furthermore, the closure/securing components in question mesh into one another by mechanically being brought into contact with their respective edge-sided functional surfaces.

As a result, the closure/securing components in question for example are immobilized against one another and secure a lateral door of the motor vehicle door latch, a sunroof, etc. Furthermore, the closure/securing components can thus assist in a closure process or define this as such. The pre-requisite in all cases is a defined relative alignment to one another or adjacency to one another.

As the known closure/securing components are usually manufactured by stamping from flat material, in particular sheet metal or strips as a base material for cost reasons, in such stamping processes surface structures can occur on the cutting edges and consequently the angular edges of the closure/securing components. These surface structures are usually cutting grooves or generally grooves to crack edges. If such angular edges with processing traces now meet one another as edge-sided functional surfaces or glide along one another, changing frictional relationships are set which are attributable to a certain runner effect between the individual surface structures or grooves.

As a consequence hereof, the problem exists for the known closure/securing components with the processing traces on their angular edges and the functional surfaces as components of these angular edges caused by the production process that indifferent functional states are observed. Because the changing frictional relationships during gliding of the closure/securing components during a change between, for example, release and blocks can lead to the functional state ‘Block’ or ‘Release’ not being securely assumed or not corresponding to a defined position of the closure/securing components to one another.

In the class-specific state of the art in accordance with DE 10 2007 060 626 A1 it is therefore suggested that the surface structures of the power transmission element produced as a result of the stamping or cutting process run at an angle to one another in the installation position to the surface structure of the other power transmission element. This means that work takes place with surface structures of the power transmission elements or closure/securing components especially orientated towards one another. A pre-requisite for this is, on the one hand, an analysis of the surface structures and special installation measures on the other hand. Both are associated with considerable effort and therefore expense. This is where the invention wishes to help.

### SUMMARY

The invention is based on the technical problem of further developing such a motor vehicle actuator that manufacture and installation are simplified and special alignment measures can be discontinued.

In order to solve this technical problem, a class-specific state-of-the-art motor vehicle actuator within the scope of the invention is characterized in that at least one closure/securing component is equipped with an angular deflection in such a way that its unprocessed angular deflection surface, i.e. the surface of the angular deflection at least partially defines the functional surface of the relevant closure/securing component.

Within the scope of the invention work therefore takes place with a special functional surface on the at least one closure/securing component. Because, in contrast to the state of the art, this functional surface is not defined with the processing traces at the relevant angular edge. Instead, an angular deflection surface of a deflection acts as a functional surface on the relevant closure/securing component. Because the angular deflection surface represents a component of the surface of the two-dimensional base material, the angular deflection surface in question does not possess or practically does not possess processing traces which arise in the upstream production process.

This upstream production process is typically a stamping process or cutting process with the help of which the respective closure/securing component is cut out of the base material. The base material may be sheet metal, a strip or similar, typically made of metal. The contour thus cut out of the base material of the relevant closure/securing component is then equipped with the angular deflection in accordance with the invention. To this end, the closure/securing component in question is usually bent off at one end with definition of the angular deflection. The end of the angular deflection is usually a free end of the closure/securing component in question. At the other end, the closure/securing component is typically conducted, immobilized or equipped with a pivoting axis.

In principle, the angular deflection can assume any angle with a basic component of the closure/securing component. The angular deflection in the cross-section is usually formed as an L-shape. It has also been proven if the angular deflection is envisaged on the end of the closure/securing component, namely at the free end already referred to. In contrast, the other end of the closure/securing component is typically equipped with a rotational axis. In this case, the closure/securing component is a pivoting lever. Both levers or both closure/securing components are usually respectively formed as pivoting levers.

It has also been proven if the angular deflection demonstrates a length adjusted to the material thickness of the other closure/securing component. Thus, the length of the angular deflection takes into account the material thickness of the other closure/securing component. Thus, both functional surfaces of the closure/securing components are adjusted to one another by their respective width. Thus, the functional surfaces of the closure/securing components can interact with one another practically all over and the closure/securing components assume definedly at least the previously referred to functional positions “Release” on the one hand and “Lock” or “Secure” on the other hand.

The unprocessed angular deflection surface of the relevant closure/securing component is equipped on the angular edge with the processing traces on the base which are generally attributable to the upstream stamping process. This means that the processing traces or grooves thus generally demonstrate in the direction of a housing in which both closure/securing components are located. Thus, the angular edge with the processing traces on the angular deflection describes an arch or circular arch upon pivoting of the closure/securing component in question.

However, the angular edge with the processing traces in question on the angular deflection cannot enter into mechanical interaction with the functional surface on the angular edge with the processing traces of the other closure/securing component. Thus, a sharp edge of the closure/securing component equipped with the angular deflection is provided practically without processing traces without necessitating costly further processing measures of the angular edges, fine stamping if necessary, etc. here. This decreases effort and expense.

In fact, the stamped edge of the closure/securing component equipped with the angular deflection is aligned with the interacting functional surfaces averted and ultimately describes the arch-shaped movement of the relevant pivoting lever. These are the crucial advantages.

In general, each of the two levers of the closure/securing components which can be moved against each other in pairs possesses at least one functional surface. However, it can be proceeded in such a way that at least one of the two levers is equipped with several functional surfaces. In this case, the levers equipped with several functional surfaces or the relevant closure/securing component can, for example, assume different functional states. If the two levers are mechanical parts inside a motor vehicle door latch, for example, for example a catch and a pawl, the catch usually possesses several functional surfaces as one of the closure/securing components. As the other closure/securing component, the pawl, which is typically equipped with the angular deflection, can now interact with its angular deflection surface as a functional surface with the several functional surfaces of the catch.

Thus, the invention takes into account the circumstance that a pertaining locking mechanism or the stated locking mechanism components can regularly assume functional positions such as ‘pre-ratchet’ or ‘main ratchet’ and ‘open’. In the first case, the angular deflection surface of the pawl interacts with the relevant pre-ratchet functional surface on the catch, whereas the functional position mentioned in the second case corresponds to the angular deflection surface on the pawl interacting with the main ratchet functional surface of the catch.

The object of the invention is also a procedure for the manufacture of a motor vehicle actuator of the construction initially described. The individual closure/securing components are manufactured from the two-dimensional base material. In the corresponding production process, certain processing traces resulting from manufacture are located on the angular edges of the relevant closure/securing components. After the contours of the relevant closure/securing components have been cut out of the base material, at least one of the two closure/securing components is equipped with the angular deflection in accordance with the invention in such a way that the unprocessed angular deflection surface at least partially defines the functional surface of the relevant closure/securing component. In order to produce the angular deflection as such, one end of the relevant closure/securing component is regularly bent off with definition of the angular deflection. Here, the invention usually works with one of the functional settings “Release” or “Open” and “Lock/Secure” and can also assume it. In the “Release” functional setting the motor vehicle door latch releases a locking bolt 1.

### BRIEF DESCRIPTION OF THE DRAWINGS

FIG. 1 is a top plan view of two movable closure/securing components.

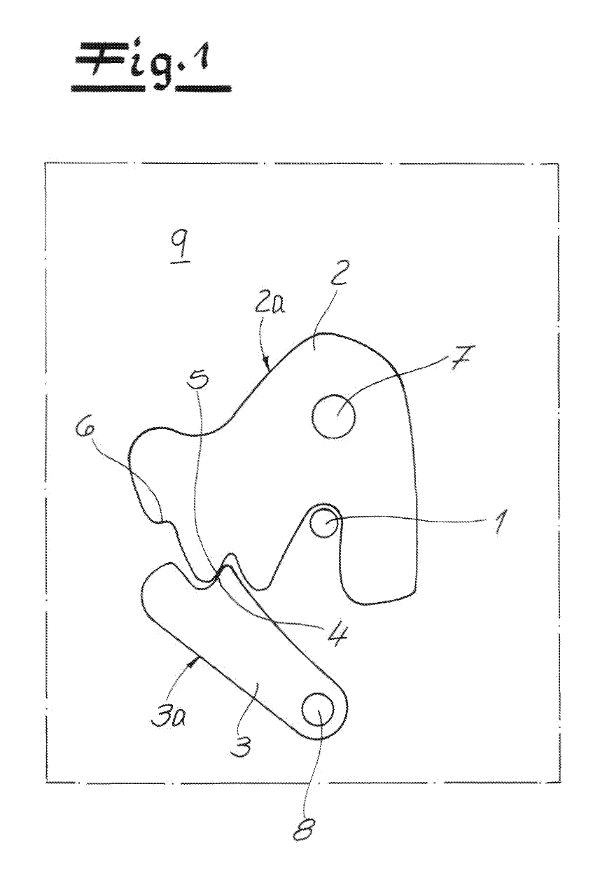

FIG. 2 is a side elevational view of the two movable closure /securing components of FIG. 1.

### DETAILED DESCRIPTION OF THE DRAWINGS

As the locking bolt 1 in the execution example is connected to a door post of a motor vehicle chassis or generally to the motor vehicle chassis, whereas the motor vehicle door latch is located internally or on a pertaining motor vehicle door, the functional setting “Release” corresponds to the motor vehicle door being able to be opened towards the motor vehicle chassis. In contrast, the motor vehicle door is closed in the functional position “Lock/Secure” of the motor vehicle door latch actuator towards the motor vehicle chassis. The two aforementioned functional positions are executed with the aid of at least two movable closure/securing components 2, 3 arranged in pairs against one another inside the motor vehicle door latch. In the execution example and not restrictedly the closure/securing components 2, 3 involve locking mechanism components of the motor vehicle door latch, namely a catch 2 and a pawl 3.

Both closure/securing components 2, 3 are respectively equipped with edge-side functional surfaces 4, 5, 6 which can be mechanically brought into contact respectively. In fact, one closure/securing component or pawl 3 possesses a functional surface 4, whereas the other closure/securing component 2, 3 or the catch 2 is equipped with two edge-side functional surfaces 5, 6.

The two closure/securing components 2, 3 are respectively levers or pivoting levers 2, 3. In fact, the catch 2 is rotatably or pivotably positioned around an axis 7 in a latch case 9, whereas the pawl 3 demonstrates its own rotational axis 8 for positioning in the latch case 9. Both rotational axes 7, 8 are defined in the execution example by bolts respectively anchored in the latch case 9 which respectively act as rotatable positioners of the closure/securing components or the catch 2 on the one hand and the pawl 3 on the other hand.

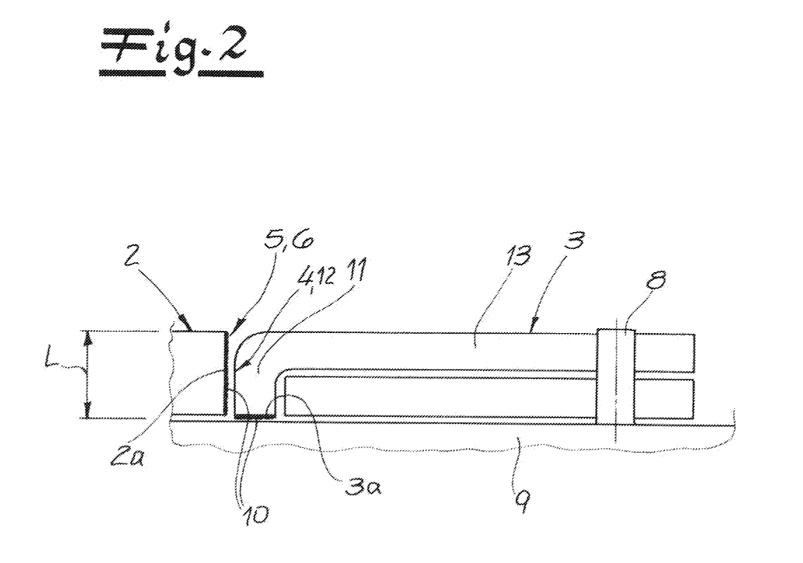

Both closure/securing components 2, 3 are respectively manufactured from a two-dimensional base material. The two-dimensional base material can be sheet metal or a strip made of metal in particular. A stamping process is usually used for production with the help of which the relevant closure/securing component 2, 3 is cut out taking into account its overall contour of the base material. Processing traces 10 are observed on the respective angular edges 2a of the catch 2 and 3a of the pawl 3 due to the described production process in the manufacture of the respective closure/securing component 2, 3 from the two-dimensional base material. These processing traces 10 are respectively represented in FIG. 2 on the pertaining angular edges 2a, 3a diagrammatically and superelevated.

In accordance with the invention, now at least one closure/securing component 2, 3 of the two closure/securing components 2, 3 movable in pairs against one another is equipped with an angular deflection 10. The relevant closure/securing component 3 equipped with the angular deflection 11 is the pawl 3 in the execution example. Naturally, this is not to be understood restrictively.

The angular deflection 11 is designed in such a way that its unprocessed angular deflection surface 12 at least partly defines the pertaining functional surface 4 of the relevant closure/securing component 3. In the execution example the angular deflection surface 12 on the one hand and the relevant functional surface 4 of the relevant closure/securing component 3 coincide.

Thus, the unprocessed angular deflection surface 12 of the angular deflection 11 on the closure/securing component 3 interacts with the functional surface 5 or 6 of the other closure/securing component 2. As the processing surface 12 of the angular deflection 11 is designed in an unprocessed or largely unprocessed manner, with the described interaction in the example case a smooth or mainly smooth metallic surface on the functional surface 4 meets the processing traces 10 on the functional surface 5, 6.

Consequently, due to the sharp edge formed the previously described functional settings “Release” on the one hand or “Lock/Secure” on the other hand are assumed clearly and defined between the two closure/securing components 2, 3. Indifferent functional states or changing frictional relationships consequently do not occur in the interaction between the functional surfaces 4, 5, 6 formed in accordance with the invention.

On the basis of the cross-sectional diagram in FIG. 2, it is recognized that the angular deflection 11 in the cross-section is an L-shape. This means that the angular deflection 11 and a basic component 13 of the pawl 3 fundamentally include a right angle. Furthermore, the angular deflection 11 is envisaged on the end side of the relevant closure/securing component 3, namely on the free end of the closure/securing component 3, opposite the rotational axis 8.

The angular deflection 11 also possesses a length L which is adjusted to the material thickness of the other closure/securing component 3. Furthermore, it is recognized that the unprocessed angular deflection surface 12 on the pawl 3 demonstrates the angular edge 3a with the processing traces 10 at the base. This means that the processing traces 10 point in the direction of the latch case 9 for positioning of the closure/securing components 2, 3 and in accordance with the invention do not come into contact with the processing traces 10 on the corresponding closure/securing component 2 or the catch 2.

1. Motor vehicle actuator, in particular a motor vehicle door actuator, preferably a motor vehicle door latch actuator, with at least two closure/securing components movable against one another in pairs, whereby the closure/securing components are respectively equipped with edge-sided functional surfaces which can mechanically be brought into contact, and whereby the closure/securing components are manufactured from a two-dimensional base material with processing traces caused by the production process on its angular edges, characterized wherein in that at least one closure/securing component is equipped with an angular deflection in such a way that its unprocessed angular deflection surface at least partly defines the functional surface of the relevant closure/securing component.

2. Device in accordance with claim 1, characterized in that the angular deflection is formed in an L shape in the cross-section.

3. Device in accordance with claim 2, characterized in that the angular deflection is envisaged on the an end side of the closure/securing component.

4. Device in accordance with claim 3, characterized in that the angular deflection demonstrates a length adjusted to the a material thickness of the other closure/securing component.

5. Device in accordance with claim 4, characterized in that the unprocessed angular deflection surface demonstrates the angular edge with the processing traces on the base.

6. Device in accordance with claim 5, characterized in that both closure/securing components are formed as pivoting levers.

7. Device in accordance with claim 6, characterized in that at least one of the two levers is equipped with several functional surfaces.

8. Device in accordance with claim 7, characterized in that the two levers involve locking mechanism components, for example a catch and a pawl.

9. Procedure for the manufacture of a motor vehicle actuator, with at least two closure/securing components which can be moved against one another in pairs, whereby the closure/securing components are respectively equipped with edge-side functional surfaces which can be mechanically brought into contact with one another, in accordance with which the closure/securing components are manufactured from a two-dimensional base material with processing traces caused by the production process on their angular edges, characterized in that at least one closure/securing component is equipped with an angular deflection in such a way that its unprocessed angular deflection surface at least partly defines the functional surface of the relevant closure/securing component.

10. Device in accordance with claim 1, characterized in that the angular deflection is on an end side of the closure/securing component.

11. Device in accordance with claim 1, characterized in that the angular deflection demonstrates a length adjusted to a material thickness of the other closure/securing component.

12. Device in accordance with claim 1, characterized in that the unprocessed angular deflection surface demonstrates the angular edge with the processing traces on the base.

13. Device in accordance with claim 1, characterized in that both closure/securing components are formed as pivoting levers.

14. Device in accordance with claim 13, characterized in that at least one of the two levers is equipped with several functional surfaces.

15. Device in accordance with claim 13, characterized in that the two levers involve locking mechanism components, for example a catch and a pawl.
